(19) United States
(12) Patent Application Publication
(10) Pub. No.: US 2021/0056558 A1
(43) Pub. Date: Feb. 25, 2021

(54) CHECKOUT SYSTEM, CHECKOUT METHOD, AND CHECKOUT APPARATUS

(71) Applicant: TOSHIBA TEC KABUSHIKI KAISHA, Tokyo (JP)

(72) Inventors: Fumio NAKATSUKASA, Yokohama Kanagawa (JP); Mikio ITO, Ota Tokyo (JP); Kiyomitu YAMAGUCHI, Izunokuni Shizuoka (JP); Shigeki NIMIYA, Yokohama Kanagawa (JP); Tsuyoshi KAWAMOTO, Nerima Tokyo (JP); Nobuhiro SUGITA, Mishima Shizuoka (JP)

(21) Appl. No.: 16/914,475

(22) Filed: Jun. 29, 2020

(30) Foreign Application Priority Data
Aug. 22, 2019 (JP) 2019-152325

(51) Int. Cl. G06Q 20/42; G06Q 20/20; G06Q 20/32

(52) U.S. Cl. CPC G06Q 20/425; G06Q 20/202; G06Q 20/3223; G06Q 20/208; G06Q 20/204

(57) ABSTRACT

A checkout system includes a store server including a first network interface, a first memory that stores payment information indicating payment methods accepted at a store, and a first processor configured to, upon receipt of a request from a customer terminal, control the first network interface to transmit the payment information to the customer terminal. The system also includes a registration server including a second network interface, a second memory, and a second processor configured to acquire the payment information from the customer terminal via the second network interface. Upon receipt of a commodity ID of a commodity from the customer terminal via the second network interface, the second processor registers the commodity ID in the second memory and, upon receipt of a request for checkout from the customer terminal, performs checkout processing using the registered commodity ID and the payment information.

### CROSS-REFERENCE TO RELATED APPLICATION

This application is based upon and claims the benefit of priority from Japanese Patent Application No. 2019-152325, filed on Aug. 22, 2019, the entire contents of which are incorporated herein by reference.

### FIELD

Embodiments described herein relates generally to a checkout system, a checkout method, and a checkout apparatus.

### BACKGROUND

A commodity sales processing system including a user terminal has been known, which allows a customer to operate the user terminal so that he or she can register a commodity to be purchased by himself or herself.

In such a commodity sales processing system, it is common for a store to lend a customer a user terminal. For example, the store attaches the user terminal to a shopping cart so that the customer can operate the user terminal to read an identification code of a commodity when putting the commodity into the shopping cart. In such a case, since the user terminal is provided by the store, various information unique to the store can be set in the user terminal in advance.

In other methods, a customer may use a communication terminal, such as a smartphone, owned by him or her as the user terminal for commodity registration. With such a personally owned communication terminal, the customer can register commodities for purchase by himself or herself at several different stores without using the user terminals provided by the stores.

In recent years, many stores have introduced rewards point (customer loyalty) services and programs independently of each other and have issued point cards for their own customers (often referred to as program members). For this reason, a customer who has become points program member at different stores may have to manage a plurality of point cards and then find and present the appropriate point card when shopping at a particular store.

Furthermore, to complete the transaction, the customer generally needs to make a payment by cash or credit card. There are various brands of credit cards issued by credit companies, banks, and even retailers themselves, such as supermarkets and convenience stores, and it sometimes depends on the stores as to which credit card brand can be accepted. Thus, the customer who owns a plurality of credit cards needs to find and present an appropriate credit card that can be used in the store at the time of credit settlement.

As such, even if a customer can use his or her personal communication terminal such as a smartphone for registering a commodity to be purchased, it may still be troublesome to find an appropriate type/brand of credit card or similar payment option that can be used in a store.

### DESCRIPTION OF THE DRAWINGS

FIG. 1 is a schematic diagram of a commodity sales processing system according to an embodiment.

FIG. 2 is a schematic diagram illustrating a data structure of store setting information.

FIG. 3 is a block diagram of a user terminal.

FIG. 4 is a schematic diagram illustrating a management table.

FIG. 5 is a block diagram of a store server.

FIG. 6 is a block diagram of a virtual POS server.

FIG. 7 is a flowchart of information processing executed by a user terminal.

FIG. 8 is a flowchart of information processing executed by a user terminal.

FIG. 9 is a flowchart of information processing executed by a user terminal.

FIG. 10 is a flowchart of information processing executed by a store server.

FIG. 11 is a flowchart of information processing executed by a virtual POS server.

FIG. 12 is a flowchart of information processing executed by a virtual POS server.

FIG. 13 is a flowchart of information processing executed by a store server.

FIG. 14 is a schematic diagram illustrating a check-in screen displayed on the user terminal.

FIG. 15 is a schematic diagram illustrating a camera screen displayed on the user terminal.

FIG. 16 is a schematic diagram illustrating a camera screen displayed on the user terminal.

FIG. 17 is a schematic diagram illustrating a wireless connection screen displayed on the user terminal.

FIG. 18 is a schematic diagram illustrating a check-in completion screen displayed on the user terminal.

FIG. 19 is a schematic diagram illustrating a registration screen displayed on the user terminal.

FIG. 20 is a schematic diagram illustrating a registration screen displayed on the user terminal.

FIG. 21 is a schematic diagram illustrating a payment selection screen displayed on the user terminal.

FIG. 22 is a schematic diagram illustrating a checkout barcode screen displayed on the user terminal.

FIG. 23 is a schematic diagram illustrating a credit card selection screen displayed on the user terminal.

### DETAILED DESCRIPTION

One or more embodiments provide a commodity sales processing system and method that allow a customer to use his or her personal communication terminal for self-service registration and furthermore avoid troublesome work associated with finding a card or the like that can be used at a store.

In general, according to one embodiment, a checkout system includes a store server and a registration server. The store server includes a first network interface, a first memory that stores payment information indicating a payment method accepted at a store, and a first processor. The first processor is configured to, upon receipt of a request from a customer terminal used by a customer, control the first network interface to transmit the payment information to the customer terminal. The registration server includes a second network interface, a second memory, and a second processor. The second processor is configured to acquire the payment information from the customer terminal via the second network interface. Upon receipt of a commodity ID of a commodity to be purchased from the customer terminal via the second network interface, the second processor is configured register the commodity ID in the second memory and, upon receipt of a request for checkout from the customer terminal, perform checkout processing using the registered commodity ID and the payment information.

Hereinafter, embodiments of a commodity sales processing system and method that allow a customer to use his or her personal communication terminal for self-service registration and also avoid difficulties associated with finding a card or the like that can be used in a store will be described with reference to the drawings.

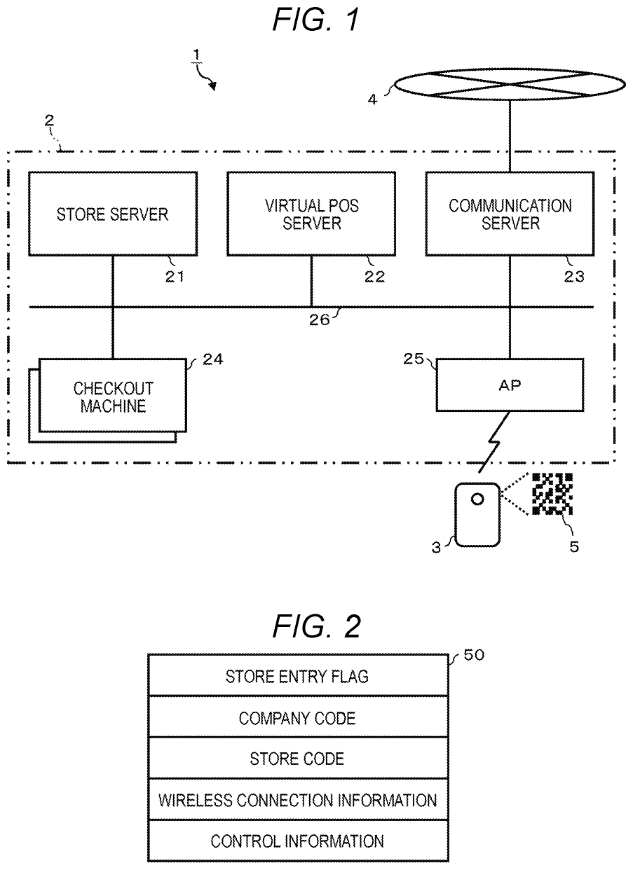

FIG. 1 is a schematic configuration diagram of a commodity sales processing system 1 according to an embodiment. The commodity sales processing system 1 includes a commodity sales system 2 and a user terminal 3. The commodity sales system 2 (also referred to as a commodity sales processing apparatus 2) includes a store server 21, a virtual POS server 22, a communication server 23, a checkout machine 24, and an access point 25, which are connected by a wired local area network (LAN) 26 or the like. The commodity sales system 2 connects the user terminal 3 to a store server 21, a virtual POS server 22, and the like and enables self-service registration using the user terminal 3. Although not specifically illustrated, the commodity sales system 2 may connect a plurality of user terminals 3 at a same time to the store server 21, the virtual POS server 22, and the like and thus enables self-service registration by each user terminal 3.

The store server 21 is a computer that supports overall store operations. The virtual POS server 22 is a computer that cooperates with the user terminal 3 to perform operations that would have normally been performed by a conventional point-of-sale (POS) terminal. The communication server 23 supports data communication with an external system via a network 4.

The checkout machine 24 is a terminal for settling a purchased commodity. A settlement method is not particularly limited. Well-known settlement methods such as cash settlement, credit card settlement, electronic money settlement, and the like can be used.

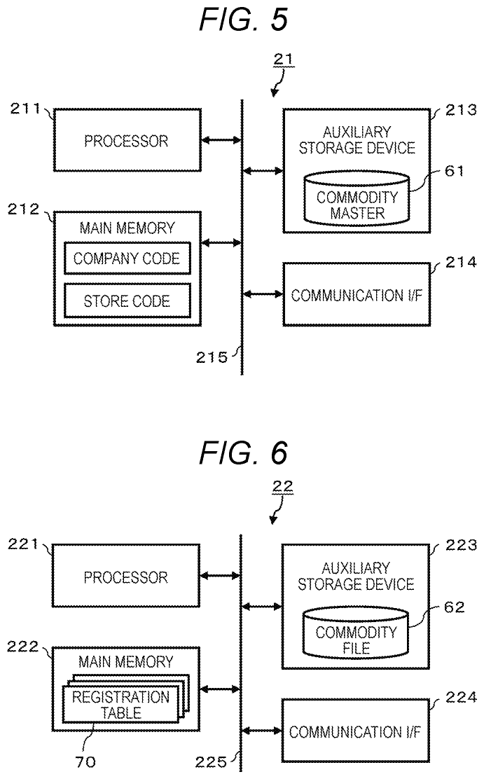

The checkout machine 24 may have a function of registering commodities being purchased. For example, when a barcode of a commodity is read by a scanner connected to the checkout machine 24, the checkout machine 24 makes an inquiry to the store server 21 by using the commodity code included in the barcode. By this inquiry, the store server 21 calls up commodity data such as the commodity name and price of the commodity identified by the commodity code from a commodity master file 61 (see FIG. 5) and outputs a reply to the checkout machine 24, and therefore the checkout machine 24 registers sales data of the commodity based on the commodity data. Then, the checkout machine 24 performs settlement for the registered commodity.

Such a checkout machine 24 may be a checkout machine at which a clerk inputs information for settlement or a self-service checkout machine at which a customer inputs information for settlement. The commodity sales system 2 may include both types of checkout machines, or may include only one thereof. For example, as a manned checkout machine an otherwise conventional POS terminal can be utilized, and as a self-checkout machine, a an otherwise conventional self-service checkout or semi self-service checkout machine can be utilized.

The access point 25 is a communication device installed in a store as a relay device for communication with servers (e.g., store server 21, virtual POS server 22, communication server 23, and the like) of the commodity sales system 2 from the user terminal 3 via a wireless LAN. The wireless LAN conforms to, for example, the standard of Wi-Fi®. In FIG. 1, only one access point 25 is specially illustrated, but a plurality of access points 25 may be installed and connected to the wired LAN 26 depending on the size of the store or the like.

A commodity sales system 2 having such a configuration is provided in each of a plurality of different stores where self-service registration of commodities by using the user terminal 3 such as a smartphone and the like personally owned by a customer is to be enabled. Alternatively, a communication terminal such as a tablet terminal or the like, owned by the relevant store and attached to a shopping cart to be used at the store may be also provided as the user terminal 3 for self-service registration of commodities. In such a case, at the store, a customer can use either the personal terminal or the terminal attached to the shopping cart as a user terminal 3 for commodity registration.

The user terminal 3 is a portable communication terminal. The user terminal 3 has hardware for reading at least a two-dimensional data code 5. For example, a commercially available smartphone, tablet terminal, or the like that is equipped with a digital camera can be used as the user terminal 3. In an embodiment, a communication terminal such as a smartphone and the like personally owned by a customer is used as the user terminal 3.

The data code 5 can be prepared by each store, for example, affixed to a product label or printed on a price tag. The data code 5 can be prepared, for example, when the corresponding product to be labeled is first placed in the store. The data code 5 is generated by encoding store setting information 50 (see FIG. 2) specific to a store or a business entity operating the store. The values of the store setting information 50 can vary depending on the store.

FIG. 2 is a schematic diagram illustrating a data structure of the store setting information 50. As illustrated in FIG. 2, the store setting information 50 includes a store entry flag, a company code, a store code, wireless connection information, and control information.

The store entry flag is 1-bit data for identifying whether the two-dimensional data code 5 is a data code for check-in at the store. In an embodiment, the store entry flag of the data code 5 for permitting check-in at the store is set to “1”.

The company code is business entity identification data settable for each business entity to identify the business entity that has prepared the data code 5 and presumably operates the store. The store code is store identification data set for each store to identify the store that has prepared the data code 5. Store codes may overlap between different business entities.

The wireless connection information is information necessary for connecting the commodity sales system 2 of the store specified by the company code and the store code and the user terminal 3 by wireless communication. For example, the wireless connection information includes a service set identifier (SSID) that is the identification name of the access point 25, a password for the wireless LAN in the store, data indicating an encryption key of the security method (e.g., WPA2-PSK, WPA-PSK, WEP and the like) set for the wireless LAN in the store, and the like.

The control information is information necessary for controlling the operation of the user terminal 3. For example, the control information indicates a timeout period until an error occurs in communication by the wireless LAN, a retry count when an error occurs, a threshold value for battery check, and the like. The threshold value may be set to any value to prohibit the use of the user terminal 3 when the remaining battery level of the user terminal 3 is equal to or less than the threshold value so that the user terminal 3 is not out of battery during shopping.

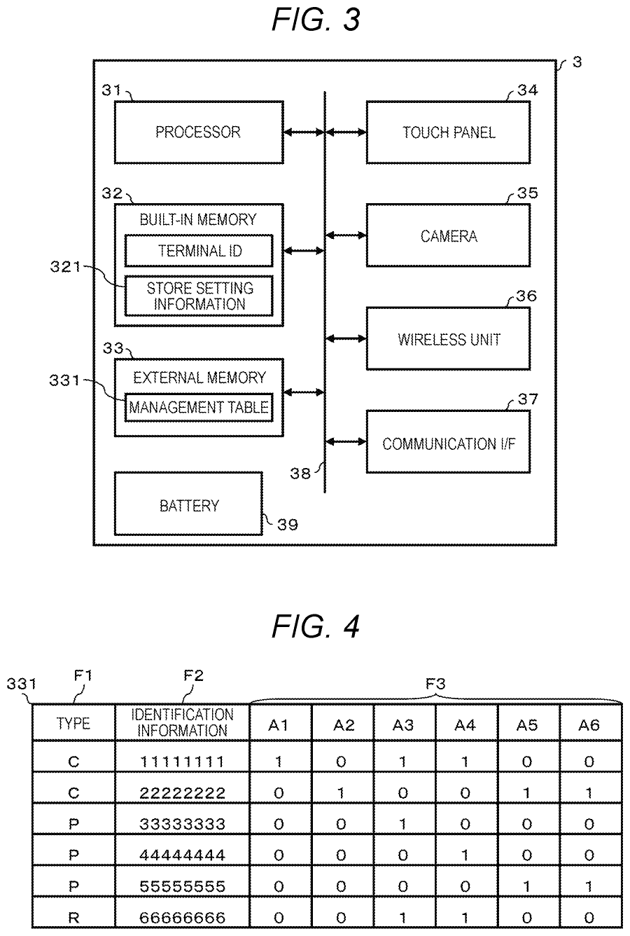

FIG. 3 is a block diagram of the user terminal 3. As illustrated in FIG. 3, the user terminal 3 includes a processor 31, a built-in memory 32, an external memory 33, a touch panel 34, a camera 35, a wireless unit 36, a communication interface (I/F) 37, and a system transmission line 38. The user terminal 3 has a rechargeable battery 39.

The system transmission line 38 is an address bus, a data bus, a control signal line, or the like. In the user terminal 3, the processor 31, the built-in memory 32, the external memory 33, the touch panel 34, the camera 35, the wireless unit 36, and the communication interface 37 are connected via the system transmission line 38.

The processor 31 controls each unit of the user terminal 3 to perform various functions according to an operating system or an application program. The processor 31 is, for example, a central processing unit (CPU).

The built-in memory 32 includes a nonvolatile memory area and a volatile memory area. The built-in memory 32 stores an operating system and/or an application program in the nonvolatile memory area. The built-in memory 32 stores data necessary for the processor 31 to control each unit of the user terminal 3 in the volatile memory area. The built-in memory 32 uses the volatile memory area as a work area in which data is rewritten by the processor 31. The nonvolatile memory area is, for example, a read only memory (ROM). The volatile memory area is, for example, a random access memory (RAM).

The external memory 33 is an auxiliary storage device, such as an SD memory card, a USB memory, or the like. The external memory 33 stores data used when the processor 31 performs various types of processing, data created by the processing in the processor 31, and the like. The external memory 33 may store the application program described above.

The touch panel 34 is a device having both an input device and a display device of the user terminal 3. The touch panel 34 detects a touch position with respect to a displayed image and outputs the touch position information to the processor 31.

The camera 35 is an imaging device built in the user terminal 3. The camera 35 operates as a device that captures still images or moving images or as a data code scanning device such as a barcode or a two-dimensional code according to an application program installed in the user terminal 3. The camera 35 may operate as a code reader.

The wireless unit 36 is a circuit for performing data communication with the access point 25 according to a wireless LAN communication protocol.

The communication interface 37 is a circuit for performing data communication with an external device connected via the Internet or a mobile communication network.

The user terminal 3 having such a configuration stores, as an application program stored in the built-in memory 32 or the external memory 33, a shopping support program used during shopping at a store where the commodity sales processing system 1 is introduced. The method for installing the shopping support program in the built-in memory 32 or the external memory 33 is not particularly limited. The shopping support program can be installed in the built-in memory 32 or the external memory 33 from a removable recording medium or downloaded from another computer via a network. Any recording medium can be used to install the shopping support program, e.g., an SD memory card or a USB memory.

The user terminal 3 stores a terminal ID in the nonvolatile memory area of the built-in memory 32. The terminal ID is terminal identification data set for identifying each user terminal 3. The user terminal 3 uses a part of the volatile memory area in the built-in memory 32 as an area 321 for storing the store setting information 50. In the area 321, the store setting information 50 obtained by analyzing the data code image captured by the camera 35 is stored.

The user terminal 3 uses a part of the memory area in the external memory 33 to store a management table 331. The management table 331 is a data table for managing payment methods associated with a customer and available at stores that allow self-service registration of commodities using the user terminal 3 personally owned by the customer. The identification information includes, for example, identification information of a credit card, identification information of a membership card, identification information of an electronic receipt user, and the like.

FIG. 4 is a schematic diagram illustrating the management table 331. As illustrated in FIG. 4, the management table 331 includes a first field F1 of type, a second field F2 of identification information, and a third field F3 of setting flag. A plurality of third fields F3 are provided for each code “An” (where n is 1, 2, 3 . . . ). FIG. 4 illustrates the management table 331 in which six third fields F3 of codes A1 to A6 are provided.

The code An is a code consisting of a company code and a store code. For example, when the company code is “001” and the store code is “0001”, the code An is “0010001”. Alternatively, the code An may be “0001001”. Hereinafter, the code An is referred to as a combination code An.

The data stored in the first field F1 is “C”, “P” or “R” in the present embodiment. Data “C” represents a credit card. Data “P” represents a point card (that is, a customer loyalty program member card). Data represents an electronic receipt user (that is, an electronic receipt service user).

The data stored in the second field F2 is determined by the data stored in the corresponding first field F1. Specifically, when the data stored in the first field F1 is “C”, the identification information of the credit card is stored in the corresponding second field F2. The identification information for the credit card may be a card number or a link ID that has been set for linking a credit card.

In this context “credit card” includes a credit card issued by a credit company, a bank card issued by a bank, a retail card issued by a retailer such as a supermarket and a convenience store, and the like. Which card can be used depends on stores. The communication server 23 of the store that allows credit card settlement is connected to a server of a credit card issuing company or a management company via the network 4.

When the data stored in the first field F1 is “P”, the identification information of the membership card is stored in the corresponding second field F2. The identification information of the membership card is, for example, a point card number.

In this context, “membership card” is a card issued to a customer who has become a member to receive services provided by the store. The services include a loyalty points service and a discount service or the like. In general, such a membership card can only be used at the store that has issued the card or another store operated by the same business entity issuing the card. In some examples, the membership card can be used at stores or locations affiliated with the particular company that provides the associated member services.

When the data stored in the first field F1 is “R”, the identification information of the electronic receipt user is stored in the corresponding second field F2. The identification information of the electronic receipt user is an electronic receipt ID for specifying a communication terminal of a customer who has downloaded an application program for the electronic receipt service. Hereinafter, the application program for the electronic receipt service is referred to as an electronic receipt application.

A customer who wants to receive an electronic receipt downloads the electronic receipt application to his or her communication terminal such as a smartphone and the like. Then, a new electronic receipt ID is set for the communication terminal. When shopping at a store that provides the electronic receipt service, the customer can receive an electronic receipt by presenting the electronic receipt ID to the store. The communication server 23 of the store that provides the electronic receipt service is connected via the network 4 to an electronic receipt server operated by an electronic receipt service operating company. The communication server 23 adds the electronic receipt ID to the receipt data for the transaction and transmits the transaction data to the electronic receipt server. By operating the communication terminal to access the electronic receipt server via the Internet and notifying the electronic receipt ID, the customer can browse the receipt data to which the electronic receipt ID has been added.

The customer who owns a credit card performs an operation for setting the identification information of the credit card in the management table 331. With this operation, the identification information of the credit card is set in the first field F1 and the second field F2 of the management table 331 together with the type “C”. Then, in the third field F3, the setting flag corresponding to the combination code An of the store code and the company code of the store where the credit card can be used is “1” indicating being valid, and the setting flag corresponding to the other combination codes An is “0” indicating being invalid.

The customer who owns a membership card performs an operation for setting the identification information of the membership card in the management table 331. With this operation, the identification information of the membership card is set in the first field F1 and the second field F2 of the management table 331 together with the type “P”. Then, in the third field F3, the setting flag corresponding to the combination code An of the store code and the company code of the store where the membership card can be used is “1” and the setting flag corresponding to the other combination codes An is “0”.

The customer who has acquired an electronic receipt ID performs an operation for setting the electronic receipt ID in the management table 331. With this operation, the electronic receipt ID is set in the first field F1 and the second field F2 of the management table 331 together with the type “R”. Then, in the third field F3, the setting flag corresponding to the combination code An of the store code and the company code of the store providing the electronic receipt service is “1”, and the setting flag corresponding to the other combination codes An is “0”.

The operation for setting various types of identification information in the management table 331 is not particularly limited. The customer may operate the user terminal 3 to make the setting, or may operate a personal computer or the like to which the user terminal 3 is connected to make the setting. For the setting flag, for example, the store server 21 refers to the data of the management table 331 from the user terminal 3 wirelessly connected via the access point 25. Then, among the setting flags belonging to the combination codes An of the store ID and the company ID of the store where the store server 21 is installed, the store server 21 sets the setting flag corresponding to the identification information usable in the store to “1” and sets the setting flag corresponding to the unusable identification information to “0”. By doing so, the management table 331 as illustrated in FIG. 4 is created in the external memory 33 of the user terminal 3.

FIG. 5 is a block diagram of the store server 21. The store server 21 includes a processor 211, a main memory 212, an auxiliary storage device 213, a communication interface 214, and a system transmission line 215. The system transmission line 215 is an address bus, a data bus, a control signal line, or the like. In the store server 21, the processor 211, the main memory 212, the auxiliary storage device 213, and the communication interface 214 are connected via the system transmission line 215.

The processor 211 controls each unit of the store server 21 to perform various functions according to an operating system or an application program. The processor 211 is, for example, a CPU.

The main memory 212 includes a nonvolatile memory area and a volatile memory area. The main memory 212 stores an operating system or application program in the nonvolatile memory area. The main memory 212 may store data necessary for the processor 211 to execute processing for controlling each unit of the store server 21 in the nonvolatile or volatile memory area. The main memory 212 uses the volatile memory area as a work area where data is rewritten by the processor 211. The nonvolatile memory area is, for example, a ROM. The volatile memory area is, for example, a RAM.

The auxiliary storage device 213 is an auxiliary storage device, such as an electric erasable programmable read-only memory (EEPROM), a hard disk drive (HDD), a solid state drive (SSD), or the like. The auxiliary storage device 213 stores data used when the processor 211 performs various processing, data created by the processor 211, and the like. The auxiliary storage device 213 may store the above-described application program.

The application program stored in the main memory 212 or the auxiliary storage device 213 includes a control program described with respect to information processing executed by the store server 21. The method for installing the control program in the main memory 212 or the auxiliary storage device 213 is not particularly limited. The control program can be installed in the main memory 212 or the auxiliary storage device 213 from a removable recording medium or another computer via a network. Any recording medium can be used to install the application program, e.g., a CD-ROM or a memory card.

The communication interface 214 is connectable to the wired LAN 26. The communication interface 214 transmits and receives data to and from the virtual POS server 22, the communication server 23, the checkout machine 24, and the access point 25 via the wired LAN 26.

The processor 211 of the store server 21 can control the communication interface 214 to transmit and receive data to and from the user terminal 3 wirelessly connected to the access point 25. Here, the communication interface 214 functions as a communication unit to communicate with the user terminal 3 owned by the customer by using wireless communication.

The store server 21 having such a configuration stores, in the non-volatile memory area of the main memory 212, a store code of a store that manages the store server 21 and a company code of a business entity that operates the store.

The store server 21 stores the commodity master file in the auxiliary storage device 213. The commodity master file 61 is an aggregate of commodity records describing relevant data for commodities sold at the store. The commodity record includes commodity data such as a commodity code, a price, and a commodity name. The commodity code is commodity identification data set for each commodity in order to uniquely identify each commodity by at least type. Usually, a barcode representing a commodity code is attached to each commodity.

FIG. 6 is a block diagram of the virtual POS server 22. The virtual POS server 22 includes a processor 221, a main memory 222, an auxiliary storage device 223, a communication interface 224, and a system transmission line 225. The system transmission line 225 is an address bus, a data bus, a control signal line, or the like. In the virtual POS server 22, the processor 221, the main memory 222, the auxiliary storage device 223, and the communication interface 224 are connected via the system transmission line 225.

The processor 221 controls each unit of the virtual POS server 22 to perform various functions according to an operating system or an application program. The processor 221 is, for example, a CPU.

The main memory 222 includes a nonvolatile memory area and a volatile memory area. The main memory 222 stores an operating system or application program in the nonvolatile memory area. The main memory 222 may store data necessary for the processor 221 to execute processing for controlling each unit in the nonvolatile or volatile memory area. The main memory 222 uses the volatile memory area as a work area where data is rewritten by the processor 221. The nonvolatile memory area is, for example, a ROM. The volatile memory area is, for example, a RAM.

The auxiliary storage device 223 is an auxiliary storage device such as an EEPROM, HDD, or SSD. The auxiliary storage device 223 stores data used when the processor 221 performs various processing, data created by the processor 221, and the like. The auxiliary storage device 223 may store the above-described application program.

The application program stored in the main memory 222 or the auxiliary storage device 223 includes a control program described with respect to information processing executed by the virtual POS server 22. The method for installing the control program in the main memory 222 or the auxiliary storage device 223 is not particularly limited. The control program can be installed in the main memory 222 or the auxiliary storage device 223 from a removable recording medium or another computer via a network. Any recording medium may be used to install the control program, e.g., a CD-ROM or a memory card.

The communication interface 224 is connectable to the wired LAN 26. The communication interface 224 transmits and receives data to and from the store server 21, the communication server 23, the checkout machine 24, and the access point 25 via the wired LAN 26.

The processor 221 of the virtual POS server 22 can control the communication interface 224 to transmit and receive data to and from the user terminal 3 wirelessly connected to the access point 25. Here, the communication interface 224 functions as a communication unit to communicate with the user terminal 3 owned by the customer by using wireless communication.

The virtual POS server 22 having such a configuration uses a part of the volatile memory area in the main memory 222 as an area for creating a registration table 70. The registration table 70 is created for each user terminal 3 connected via a communication unit. The registration table 70 is a data table for accumulating sales data and the like of commodities registered by the user terminal 3.

The virtual POS server 22 stores a commodity file 62 in the auxiliary storage device 223. In the commodity file 62, at least the commodity name and the unit price of a commodity record stored in the commodity master file 61 are copied. Then, each time a unit price of a commodity record stored in the commodity master file 61 is changed, for example, the commodity record stored in the commodity file 62 is updated in real time. Since the method of updating the commodity record stored in the commodity master file 61 is well known, the description thereof is omitted here.

Here, the commodity file 62 stores commodity data including the name and price of the commodity identified by commodity identification data in association with the commodity identification data. The commodity master file stores at least the commodity data stored in the commodity file 62.

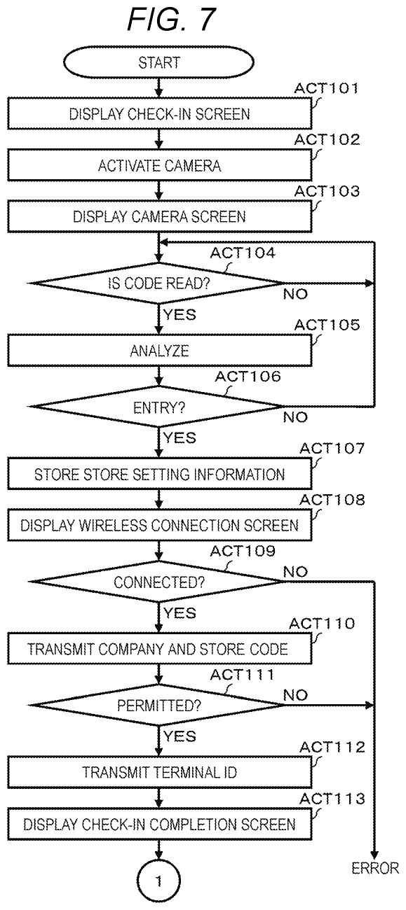

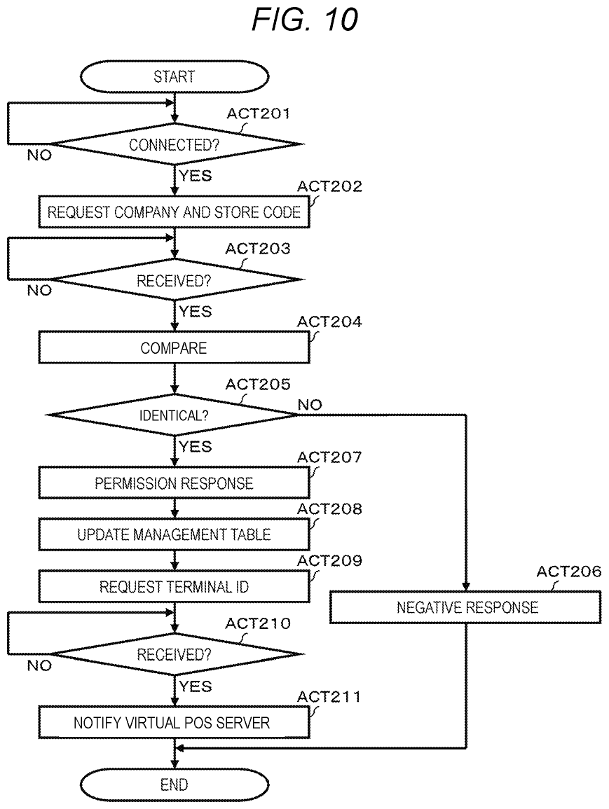

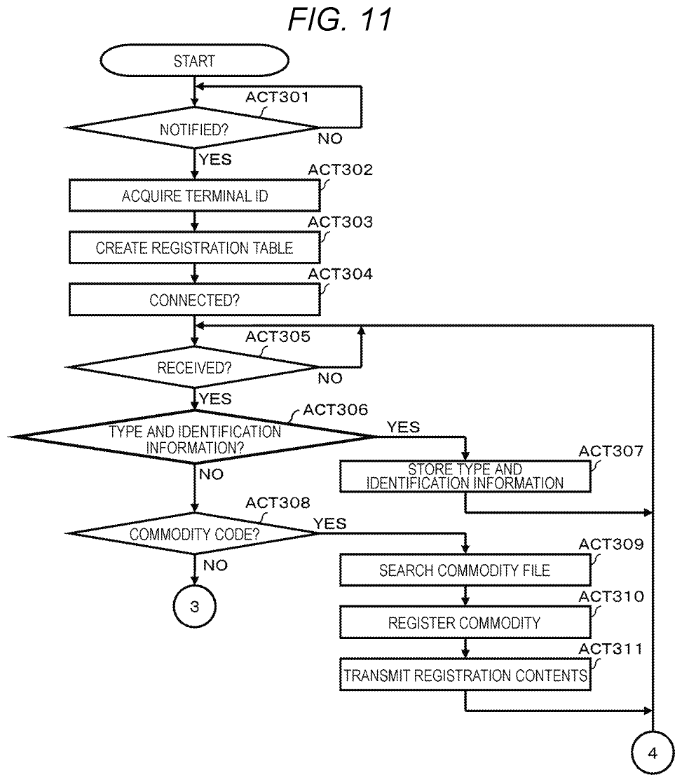

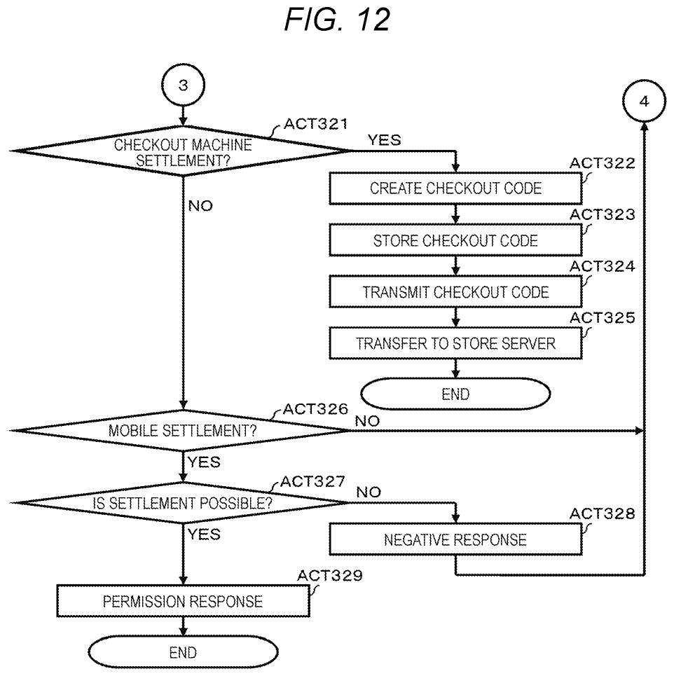

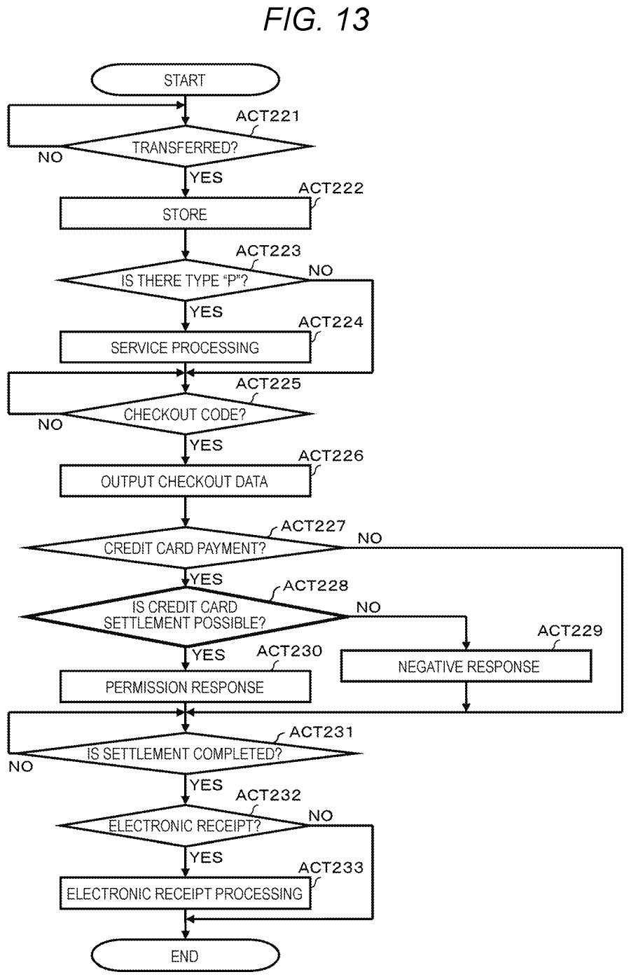

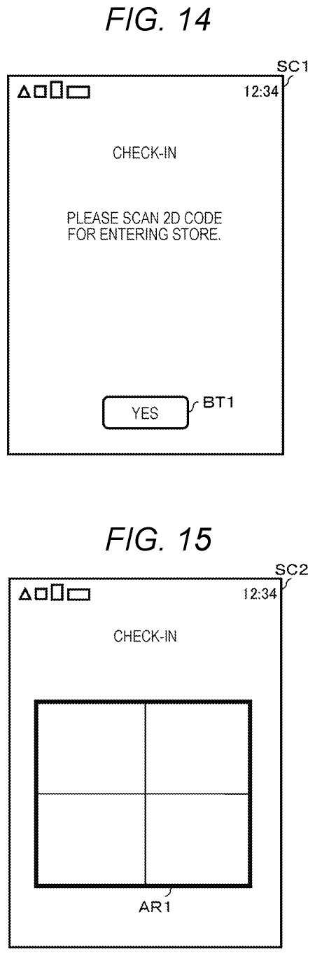

FIGS. 7 to 9 are flowcharts of information processing executed by the processor 31 of the user terminal 3 based on the shopping support program. FIGS. 10 and 13 are flowcharts of information processing executed by the processor 211 of the store server 21 based on the control program stored in the main memory 212 or the auxiliary storage device 213. FIGS. 11 and 12 are flowcharts of information processing executed by the processor 221 of the virtual POS server 22 based on the control program stored in the main memory 222 or the auxiliary storage device 223. FIGS. 14 to 23 are schematic diagrams illustrating various screens displayed on the touch panel 34 of the user terminal 3. Hereinafter, main operations of the commodity sales processing system 1 including the commodity sales system 2 and the user terminal 3 will be described with reference to these drawings. This operation description will clarify the commodity sales processing method of the commodity sales system 2. The content of the operation described below is an example. The operation procedure and the contents of the operation are not particularly limited as long as similar results can be obtained.

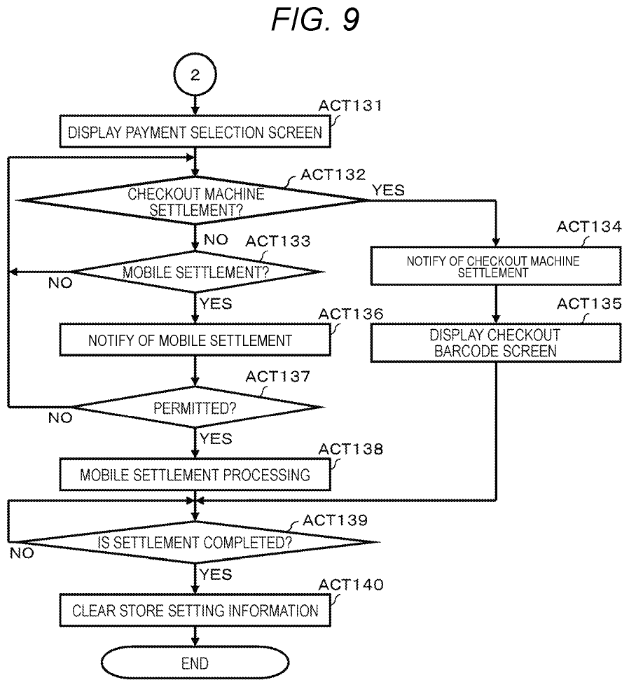

When a customer goes to a store where the commodity sales processing system 1 is installed, the customer starts the shopping support program installed on the user terminal 3 before starting shopping. Then, the processor 31 starts the information processing of the procedure illustrated in the flowcharts of FIGS. 7 and 9.

First, the processor 31 controls the touch panel 34 to display a check-in screen SC1 (see FIG. 14) (ACT 101).

FIG. 14 is an example of the check-in screen SC1. As illustrated in FIG. 14, on the check-in screen SC1, along with a message instructing to scan the two-dimensional code for entering the store, an image of a “Yes” button BT1 for indicating that the customer has confirmed the message is displayed. After confirming the check-in screen SC1, the customer touches the “Yes” button BT1.

When it is detected that the “Yes” button BT1 of the check-in screen SC1 has been touched by a signal from the touch panel 34, the processor 31 activates the camera 35 (ACT 102). Then, the processor 31 controls the touch panel 34 to display a camera screen SC2 (see FIG. 15) (ACT 103).

FIG. 15 is an example of the camera screen SC2. As illustrated in FIG. 15, an image AR1 indicating an area for reading a two-dimensional code is displayed on the camera screen SC2. After confirming the camera screen SC2, the customer holds the user terminal 3 over the data code 5 so that the data code 5 prepared at the entrance of the store falls within the image AR1.

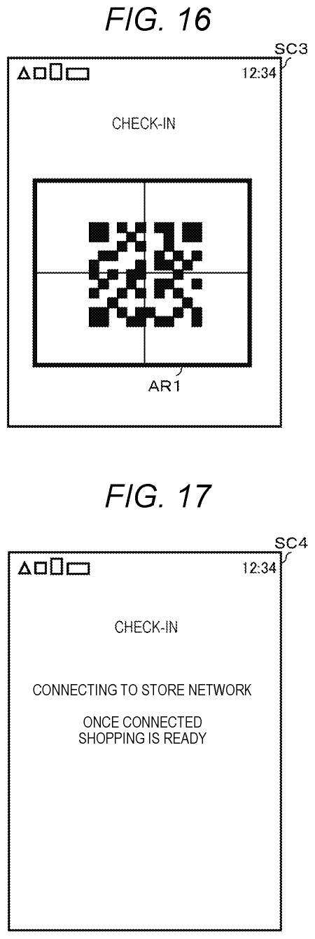

After the camera screen SC2 has been displayed, the processor 31 waits for the camera 35 to read the two-dimensional data code (ACT 104). As illustrated in FIG. 16, when the two-dimensional data code falls within the image AR1, the processor 31 determines that the data code has been read. The processor 31 determines YES in ACT 104 and proceeds to ACT 105.

The processor 31 analyzes data coded by the data code from the image of the data code captured by the camera 35 (ACT 105). Then, the processor 31 determines whether the data code read is the data code 5 in which the store entry flag is set to “1” (ACT 106).

If the data code read by the camera 35 is not the data code 5 in which the store entry flag is set to “1”, the processor 31 determines NO in ACT 106 and returns to ACT 104. The processor 31 waits for the camera 35 to read the two-dimensional data code, again.

If the data code read by the camera 35 is the data code 5 in which the store entry flag is set to “1”, the processor 31 determines YES in ACT 106 and proceeds to ACT 107. The processor 41 stores, in the area 321 of the built-in memory 32, the store setting information 50 including the store entry flag, the company code, the store code, the wireless connection information, and the control information obtained by analyzing the data code 5 (ACT 107).

The processor 31 controls the touch panel 34 to display a wireless connection screen SC4 (see FIG. 17) (ACT 108).

FIG. 17 is the example of the wireless connection screen SC4. As illustrated in FIG. 17, on the wireless connection screen SC4, a message indicating that the user terminal 3 is connected to a wireless network inside the store, and that shopping is possible when the connection is completed is displayed. Then, the shopper waits for the user terminal 3 to be connected to the wireless network inside the store.

The processor 41 controls the wireless unit 36 based on the wireless connection information of the store setting information 50 stored in the area 321 (ACT 109) and waits for the user terminal 3 to be connected to the wireless network inside the store. Here, when the connection to the wireless network inside the store is not made even after the time corresponding to the timeout time included in the control information of the store setting information 50 has elapsed, the processor 31 repeatedly retries for up to the number of retries included in the control information. If the connection with the wireless network inside the store is not possible even after the retry has been repeated, the processor 31 determines NO in ACT 109 and outputs a communication error. The processor 31 executes the retry for connection, for example, after a certain time interval.

As illustrated in FIG. 10, the processor 211 of the store server 21 waits for the connection from the user terminal 3 (ACT 201). When the user terminal 3 is connected to the store server 21 via the access point 25 so as to be able to perform wireless communication, the processor 211 determines YES in ACT 201 and proceeds to ACT 202. The processor 211 controls the communication interface 214 to transmit a command requesting a company code and a store code to the user terminal 3 (ACT 202). With this control, a code request command is transmitted from the communication interface 214 to the user terminal 3. The code request command is wirelessly transmitted via the access point 25 and received by the wireless unit 36 of the user terminal 3.

In ACT 109 of FIG. 7, the processor 31 of the user terminal 3 determines YES when connected to the in-store wireless network and proceeds to ACT 110. In response to the code request command from the store server 21, the processor 31 controls the wireless unit 36 to wirelessly transmit the company code and the store code included in the store setting information 50 (ACT 110). With this control, data of the company code and the store code is wirelessly transmitted from the wireless unit 36, and the data is received by the store server 21 via the access point 25.

In ACT 202 of FIG. 10, the processor 211 of the store server 21 that has controlled the transmission of the code request command waits for the data of the company code and the store code (ACT 203). Upon receiving the data of the company code and the store code via the communication interface 214, the processor 211 determines YES in ACT 203 and proceeds to ACT 204. The processor 211 compares the store code and the commodity code received with the store code and the company code stored in the main memory 212 (ACT 204). Then, the processor 211 determines whether those store codes and company codes are identical (ACT 205).

As a result of the comparison, if either the store codes or the company codes are not identical, the processor 211 determines NO in ACT 205 and proceeds to ACT 206. The processor 211 controls the communication interface 214 to transmit a negative acknowledge reply command to the user terminal 3 (ACT 206). With this control, the negative acknowledge reply command is transmitted from the communication interface 214 to the user terminal 3. The negative acknowledge reply command is wirelessly transmitted from the access point 25 and received by the wireless unit 36 of the user terminal 3. The processor 211 that has controlled the transmission of the negative acknowledge reply command ends the information processing of the procedure illustrated in the flowchart of FIG. 10.

On the other hand, when both the store codes and the company codes match, the processor 211 determines YES in ACT 205 and proceeds to ACT 207. The processor 211 controls the communication interface 214 to transmit an acknowledge reply command to the user terminal 3 (ACT 207). With this control, the acknowledge reply command is transmitted from the communication interface 214 to the user terminal 3. The acknowledge reply command is wirelessly transmitted from the access point 25 and received by the wireless unit 36 of the user terminal 3.

The processor 211 that has controlled the transmission of the acknowledge reply command updates the management table 331 stored in the user terminal 3 (ACT 208). Specifically, the processor 211 confirms whether there is the third field F3 in which the combination code An of the company code and the store code of the store server 21 is set, in the management table 331. If there is no combination code An, the third field F3 in which the combination code An is set is added to the management table 331. Then, a setting flag is set in the third field F3. That is, the setting flag with the type of the first field “C” is set to “1” when the credit card specified by the identification information in the second field F2 is accepted at the store, and is set to “0” when the credit card is unacceptable. The setting flag with the type of the first field of “P” is set to “1” when the membership card specified by the identification information of the second field F2 can be used at the store, and is set to “0” when the membership card cannot be used. The setting flag with the type of the first field of “R” is set to “1” when the store provides the electronic receipt service, and is set to “0” when the store does not provide the electronic receipt service.

On the other hand, if there is already the third field F3 in which a combination code An of the company code and the store code of the store server 21 is set, the processor 211 examines the setting flag of the third field F3 in the same manner as described above.

After updating the management table 331 in this manner, the processor 211 controls the communication interface 214 to transmit a command requesting a terminal ID to the user terminal 3 (ACT 209). With this control, the ID request command is transmitted from the communication interface 214 to the user terminal 3. The ID request command is wirelessly transmitted from the access point 25 and received by the wireless unit 36 of the user terminal 3.

In ACT 110 of FIG. 7, the processor 31 of the user terminal 3, which has controlled the transmission of the company code and the store code, waits for the reception of the acknowledge reply command (ACT 111). In this waiting state, if the negative acknowledge reply command is received, the processor 31 determines NO in ACT 111 and ends this processing as an error.

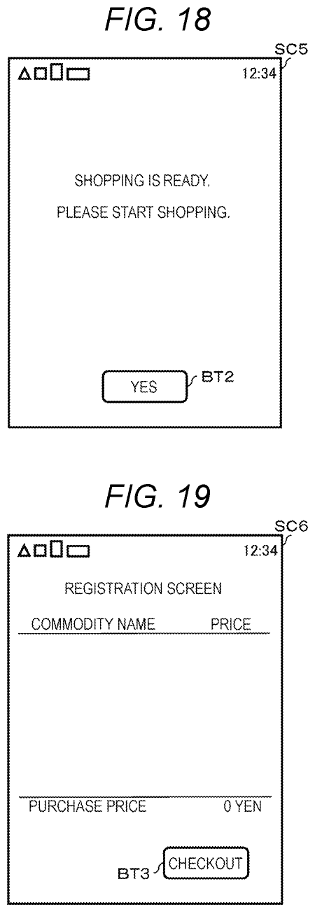

On the other hand, when the acknowledge reply command is received, the processor 31 determines YES in ACT 111 and proceeds to ACT 112. The processor 31 controls the wireless unit 36 to wirelessly transmit the terminal ID stored in the built-in memory 32 in response to the ID request command from the store server 21. With this control, the terminal ID is wirelessly transmitted from the wireless unit 36, and the terminal ID is received by the store server 21 via the access point 25. The processor 31 controls the touch panel 44 to display a check-in completion screen SC5 (see FIG. 18) (ACT 113).

FIG. 18 is an example of the check-in completion screen SC5. As illustrated in FIG. 18, on the check-in completion screen SC5, an image of a “Yes” button BT2 is displayed together with a message indicating that shopping is ready. After confirming the check-in completion screen SC5, the customer touches the “Yes” button BT2.

In ACT 209 of FIG. 10, the processor 211 of the store server 21 that has controlled the transmission of the ID request command is waiting to receive the terminal ID from the user terminal 3 (ACT 210). Upon receiving the terminal ID via the communication interface 214, the processor 211 controls the communication interface 214 to notify the virtual POS server 22 of the terminal ID. With this control, the terminal ID is transmitted from the communication interface 214 to the virtual POS server 22. The terminal ID is received by the communication interface 224 of the virtual POS server 22. The processor 211 of the store server 21 that has notified the virtual POS server 22 of the terminal ID ends the information processing of the procedure illustrated in the flowchart of FIG. 10.

As illustrated in FIG. 11, the processor 221 of the virtual POS server 22 waits for the notification of the terminal ID (ACT 301). Upon receiving the terminal ID notified from the store server 21 via the communication interface 224, the processor 221 determines YES in ACT 301 and proceeds to ACT 302. The processor 221 acquires the terminal ID notified from the store server 21 (ACT 302). Then, the processor 221 creates the registration table 70 in which the terminal ID is associated with the main memory 222.

The processor 221 controls the communication interface 214 to establish a connection with the user terminal 3 whose terminal ID is set, via the access point 25 (ACT 304). Then, when the connection with the user terminal 3 has been established, the processor 221 waits for particular data from the user terminal 3 (ACT 305).

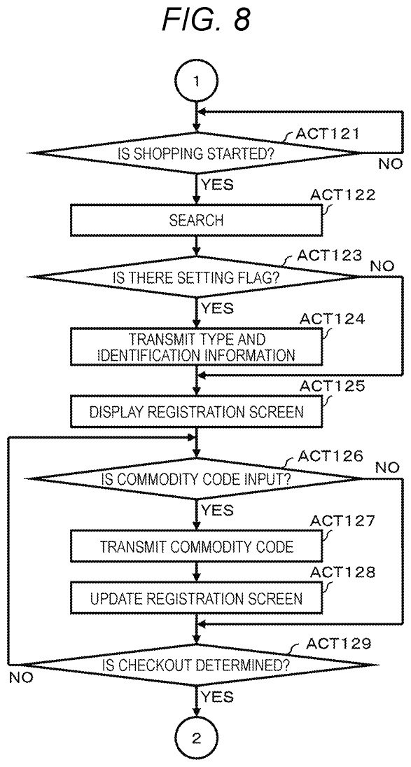

In ACT 113 of FIG. 7, the processor 31 of the user terminal 3 that has displayed the check-in completion screen SC5 waits for an instruction to start shopping (ACT 121 of FIG. 8). When it is detected that the “Yes” button BT2 on the check-in completion screen SC5 has been touched by a signal from the touch panel 34, the processor 31 determines that shopping start has been instructed. The processor 31 determines YES in ACT 121 and proceeds to ACT 122. The processor 31 searches the management table 331 by using the company code and the store code of the store setting information 50 described in the area 321 (ACT 122). Then, the processor 31 determines whether there is a setting flag set to “1” in the third field F3 to which the combination code An of the company code and the store code is assigned (ACT 123).

If there is at least one setting flag set to “1” in the third field F3, the processor 31 determines YES in ACT 123 and proceeds to ACT 124. The processor 31 controls the wireless unit 36 to wirelessly transmit the type and the identification information described in the first field F1 and the second field F2 in accordance with the setting flag set to “1” (ACT 124). With this control, the data of the type and the identification information is wirelessly transmitted from the wireless unit 36, and the data is received by the virtual POS server 22 via the access point 25.

In ACT 124, the processor 31 that has controlled the wireless transmission of the type and the identification information proceeds to ACT 125. On the other hand, when there is no setting flag set to “1” in the third field F3, the processor 31 determines NO in ACT 123, skips the processing of ACT 124, and proceeds to ACT 125. The processor 31 controls the touch panel 34 to display a registration screen SC6 (see FIG. 19) (ACT 125).

FIG. 19 is an example of the registration screen SC6. As illustrated in FIG. 19, an area for displaying a commodity name and price of the commodity and an area for a total purchase price are shown on the registration screen SC6. An image of a checkout button BT3 for instructing checkout is displayed. When the customer picks up a commodity and places the commodity in a shopping basket, a shopping cart or the like, the customer holds the user terminal 3 over the barcode attached to the commodity. Then, the barcode is scanned by the camera 35. The barcode includes the commodity code of the commodity.

In ACT 305 of FIG. 11, the processor 221 of the virtual POS server 22 determines YES when particular data wirelessly transmitted from the user terminal 3 is received by the communication interface 224 and proceeds to ACT 306. The processor 221 confirms whether the received data is data of a type and identification information (ACT 306). When the received data is the data of the type and the identification information, the processor 221 determines YES in ACT 306 and proceeds to ACT 307. The processor 221 stores the data of the type and the identification information in the registration table 70 associated with the terminal ID of the user terminal 3 (ACT 307). After that, the processor 221 returns to ACT 305 and waits for the reception of next data from the user terminal 3.

The processor 31 of the user terminal 3 which has displayed the registration screen SC6 in ACT 125 of FIG. 8, confirms whether a commodity code has been input (ACT 126). If the commodity code has not been input, the processor 31 determines NO in ACT 126 and proceeds to ACT 129. The processor 31 confirms whether the checkout button BT3 has been touched (ACT 129). If the checkout button BT3 has not been touched, the processor 31 determines NO in ACT 129 and returns to ACT 126. Here, the processor 31 waits for the input of a commodity code or the input of the checkout button BT3 in ACT 126 and ACT 129.

In the waiting states of ACT 126 and ACT 129, when a bar code is scanned by the camera 35 and a commodity code is input from the bar code data, the processor 31 determines YES in ACT 126 and proceeds to ACT 127. The processor 31 controls the wireless unit 36 to wirelessly transmit the commodity code (ACT 127). With this control, the commodity code is wirelessly transmitted from the wireless unit 36, and the commodity code is received by the virtual POS server 22 via the access point 25.

In a state of waiting for reception in ACT 305 in FIG. 11, the processor 221 of the virtual POS server 22 that has received the data from the user terminal 3 and has confirmed that the received data is not the data of the type and the identification information determines NO in ACT 306 and proceeds to ACT 308. The processor 221 confirms whether the received data is a commodity code (ACT 308). If the received data is a commodity code, the processor 221 determines YES in ACT 308 and proceeds to ACT 309. The processor 221 searches the commodity file 62 by using the commodity code (ACT 309), and acquires commodity data such as a commodity name and a price stored in association with the commodity code. After acquiring the commodity data, the processor 221 generates sales data of the commodity identified by the commodity code based on the commodity data and registers the sales data in the registration table 70 associated with the terminal ID of the user terminal 3 (ACT 310). The processor 221 controls the communication interface 224 to transmit data indicating the registered content of the registration table 70 including the sales data to the user terminal 3 (ACT 311). With this control, data indicating the registered content is transmitted from the communication interface 224, and the data indicating the registered content is wirelessly transmitted from the access point 25 and received by the user terminal 3. The processor 221 that has controlled the transmission of the data indicating the registered content returns to ACT 305 and waits for the reception of the next data.

The processor 31 of the user terminal 3 that has controlled the transmission of the commodity code in ACT 127 of FIG. 8 updates the registration screen SC6 based on the data indicating the registration content received from the virtual POS server 22 (ACT 128).

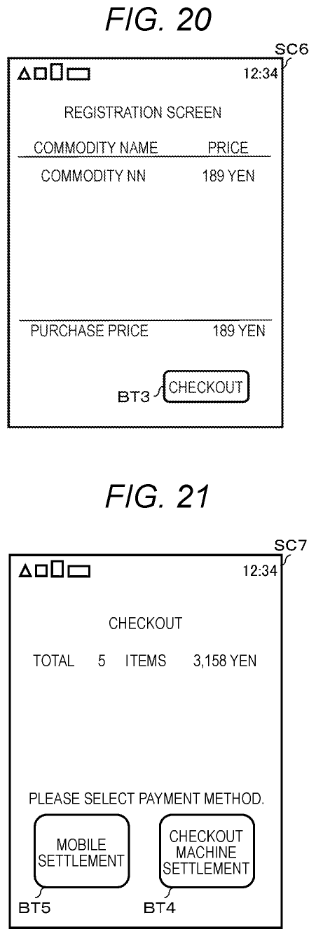

FIG. 20 is an example of the updated registration screen SC6. FIG. 20 illustrates the registration screen SC6 after the commodity code of the commodity NN having a unit price of 189 Yen has been input as a first commodity. On the registration screen SC6, the name and unit price of the commodity NN are displayed. Also, the purchase price of 189 yen is displayed.

The processor 31 that has updated the registration screen SC6 proceeds to ACT 129. That is, the processor 31 is in a standby state in ACT 126 and ACT 129.

After completing the shopping, the customer touches the checkout button BT3 on the registration screen SC6. When it is detected that the checkout button BT3 has been touched by a signal from the touch panel 34, the processor 31 determines YES in ACT 129 and proceeds to ACT 131 in FIG. 9. The processor 31 controls the touch panel 34 to display a payment selection screen SC7 (see FIG. 21) (ACT 131).

FIG. 21 is an example of the payment selection screen SC7. As illustrated in FIG. 21, on the payment selection screen SC7, images of buttons BT4 and BT5 for selecting a payment method are displayed together with the total number of purchase items and the total purchase price. The button BT4 is a button for selecting checkout machine settlement as a payment method. The button BT5 is a button for selecting mobile settlement as a payment method.

The checkout machine settlement is a method of using the checkout machine 24 to pay for the commodities by cash, credit card, electronic money, or the like. The mobile settlement is a method in which the user terminal 3 is used to pay for the commodities electronically by using a barcode or a two-dimensional code. The mobile settlement is also referred to as code settlement or smartphone settlement.

After confirming the payment selection screen SC7, the customer determines whether to use the checkout machine settlement or the mobile settlement. Then, the customer touches the button BT4 when using the checkout machine settlement. The customer touches the button BT5 when using mobile settlement.

In ACT 131, the processor 31 that has controlled the display of the payment selection screen SC7 confirms whether the checkout machine settlement has been selected (ACT 132). If the checkout machine settlement has not been selected, the processor 31 determines NO in ACT 132 and proceeds to ACT 133. The processor 31 confirms whether the mobile settlement has been selected (ACT 133). If the mobile settlement has not been selected, the processor 31 determines NO in ACT 133 and returns to ACT 132. Here, the processor 31 waits for the selection of the checkout machine settlement or the mobile settlement in ACT 132 and ACT 133.

When it is detected that the button BT4 of the payment selection screen SC7 has been touched by a signal from the touch panel 34, the processor 31 determines that the checkout machine settlement has been selected. The processor 31 determines YES in ACT 132, and proceeds to ACT 134. The processor 31 controls the wireless unit 36 to notify the checkout machine settlement (ACT 134). With this control, data for notifying the checkout machine settlement is wirelessly transmitted from the wireless unit 36, and the data is received by the virtual POS server 22 via the access point 25.

In the state of waiting for reception in ACT 305 in FIG. 11, the processor 221 of the virtual POS server 22 that has received the data from the user terminal 3 and has confirmed that the received data is neither the data of the type and the identification information nor the commodity code determines NO in ACT 308 and proceeds to ACT 321 of FIG. 12. The processor 221 confirms whether the received data is data for notifying the checkout machine settlement (ACT 321). If the received data is data for notifying the checkout machine settlement, the processor 221 determines YES in ACT 321 and proceeds to ACT 322. The processor 221 generates a checkout code (ACT 322). The checkout code is a unique code generated to identify the registration table 70 associated with the terminal ID of the user terminal 3.

The processor 221 stores the checkout code in the registration table 70 associated with the terminal ID of the user terminal 3 (ACT 323). The processor 221 controls the communication interface 224 to transmit the checkout code to the user terminal 3 (ACT 324). With this control, the checkout code is transmitted from the communication interface 224, and the checkout code is wirelessly transmitted from the access point 25 and received by the user terminal 3. The processor 221 that has controlled the transmission of the checkout code controls the communication interface 224 to transfer the data of the registration table 70 storing the checkout code to the store server 21 (ACT 325). As described above, the processor 221 ends the information processing of the procedure illustrated in the flowcharts of FIGS. 11 and 12.

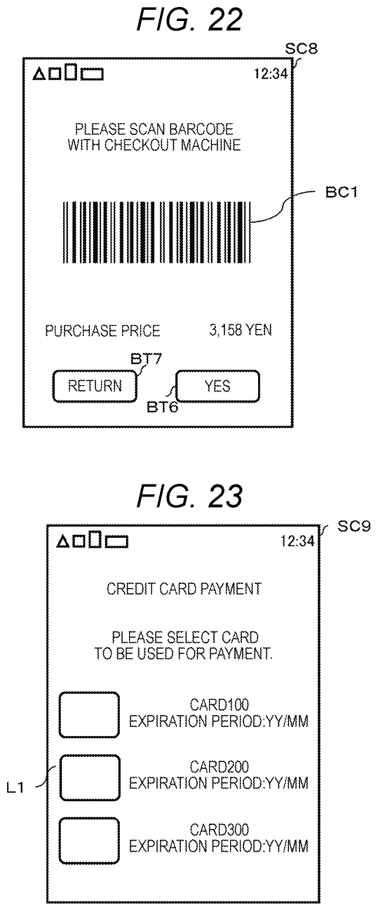

The processor 31 of the user terminal 3 that has the notification of the checkout machine settlement in ACT 134 of FIG. 9 controls the touch panel 44 to display a checkout barcode screen SC8 (see FIG. 22) based on the checkout code received from the virtual POS server 22 (ACT 135).

FIG. 22 is an example of the checkout barcode screen SC8. As illustrated in FIG. 22, on the checkout barcode screen SC8, a message prompting to scan the checkout barcode BC1 with the checkout machine 24 is displayed together with the checkout barcode BC1 in which the checkout code is represented by a barcode. On the checkout barcode screen SC8, an image of a “Yes” button BT6 for indicating that the customer has confirmed the message and a “Back” button BT7 for instructing to return to shopping are displayed.

After confirming the checkout barcode screen SC8, the customer touches the “Yes” button BT6. Then, the customer goes to the place where the checkout machine 24 is installed and reads the checkout barcode BC1 with the scanner of the vacant checkout machine 24. The checkout machine 24 that has read the checkout barcode BC1 makes an inquiry to the store server 21 by using the checkout code represented by the checkout barcode BC1.

The flow returns to the description of FIG. 9.

When it is detected that the button BT5 on the payment selection screen SC7 has been touched by a signal from the touch panel 34, the processor 31 of the user terminal 3 determines that mobile settlement has been selected. The processor 31 determines YES in ACT 133 and proceeds to ACT 136. The processor 31 controls the wireless unit 36 to notify the virtual POS server 22 of the mobile settlement being selected (ACT 136). With this control, data for notifying of the mobile settlement being selected is wirelessly transmitted from the wireless unit 36, and the data is received by the virtual POS server 22 via the access point 25.

In the state of waiting for reception in ACT 305 in FIG. 11, the processor 221 of the virtual POS server 22 that has received the data from the user terminal 3 and has confirmed that the received data is not any one of (i) the type and the identification information, (ii) the commodity code, and (iii) data for notifying of the checkout machine settlement, determines NO in ACT 321 of FIG. 12 and proceeds to ACT 326. The processor 221 confirms whether the received data is data for notifying of the mobile settlement (ACT 236). If the received data is not data for notifying of the mobile settlement, the processor 221 determines NO in ACT 326, performs processing according to the received data, and returns to the state of waiting for reception of ACT 305.

If the received data is data notifying of the mobile settlement, the processor 221 determines YES in ACT 326 and proceeds to ACT 327. The processor 221 confirms whether to approve the mobile settlement (ACT 327). For example, there are stores that approve mobile settlement and stores that do not. Alternatively, even a store that normally approves mobile settlement may not temporarily approve mobile settlement for some reason. If the mobile settlement at the store has not been approved, the processor 221 determines NO in ACT 327 and proceeds to ACT 328. The processor 221 controls the communication interface 224 to transmit a negative acknowledge reply to the user terminal (ACT 328). With this control, data of the negative acknowledge reply is transmitted from the communication interface 224, and this data is wirelessly transmitted from the access point 25 and received by the user terminal 3. The processor 221 that has controlled the transmission of the negative acknowledge reply returns to the state of waiting for reception in ACT 305.

On the other hand, if the mobile settlement at the store has been approved, the processor 221 determines YES in ACT 327 and proceeds to ACT 329. The processor 221 controls the communication interface 224 to transmit an acknowledge reply to the user terminal 3 (ACT 329). With this control, data of the acknowledge reply is transmitted from the communication interface 224, and this data is wirelessly transmitted from the access point 25 and received by the user terminal 3. As described above, the processor 221 ends the information processing of the procedure illustrated in the flowcharts of FIGS. 11 and 12.

In ACT 136 of FIG. 9, the processor 31 of the user terminal 3 that has notified of the mobile settlement confirms whether an acknowledge reply has been received and the mobile settlement is permitted (ACT 137). If a negative acknowledge reply is received instead of an acknowledge reply, the processor 31 determines NO in ACT 137 and returns to ACT 132. At this time, a pop-up message indicating that mobile settlement cannot be used is displayed on the payment selection screen SC7. The processor 31 waits for the selection of the checkout machine settlement.

If the acknowledge reply is received in ACT 137, the processor 31 determines YES and proceeds to ACT 138. The processor 31 executes mobile settlement processing (ACT 138). Since the mobile settlement processing is known processing, a description thereof will be omitted.

When the mobile settlement processing is executed in ACT 138 or the display of the checkout barcode screen SC8 is controlled in ACT 135, the processor 31 waits for the payment to be completed (ACT 139). Then, when the settlement is completed, the processor 31 determines YES in ACT 139 and proceeds to ACT 140. The processor 31 clears the store setting information 50 stored in the area 321 (ACT 140). As described above, the processor 31 ends the information processing according to the shopping support program.

FIG. 13 is a flowchart of information processing executed by the processor 211 of the store server 21 which has received the data of the registration table 70 from the virtual POS server 22. That is, the processor 211 waits for the data transfer of the registration table 70 (ACT 221). Upon receiving the data of the registration table 70 via the communication interface 214, the processor 211 determines YES in ACT 221 and proceeds to ACT 222. The processor 211 stores the data of the registration table 70 in the volatile memory area of the main memory 212 in ACT 222. Alternatively, the processor 211 stores the data of the registration table 70 in the auxiliary storage device 213.

The data of the registration table 70 stored in the main memory 212 or the auxiliary storage device 213 includes the type and the identification information stored in the processing of ACT 307 in FIG. 11. The processor 211 confirms whether the data of the registration table 70 includes the identification information of the type “P” (ACT 223). If the data does not include the identification information of the type “P”, the processor 211 determines NO in ACT 223, skips the processing of ACT 224, and proceeds to ACT 225.

When identification information of type “P” is included, the processor 211 determines YES in ACT 223 and proceeds to ACT 224. The processor 211 executes service processing based on the identification information (ACT 224). For example, when the identification information is the identification information relating to a membership card of the point service, a point is calculated based on the sales data of each commodity registered in the registration table 70, and a discount to be given to the customer is applied. For example, if the identification information indicates a membership card of the discount service, a service for discounting the purchase price of a commodity registered in the registration table 70 is executed. After finishing the service processing, the processor 211 proceeds to ACT 225.

The processor 211 waits for an inquiry of the checkout code from the checkout machine 24 (ACT 225). As described above, when the checkout barcode BC1 is read by the checkout machine 24, an inquiry is made to the store server 21 with the checkout code represented by the checkout barcode. When receiving the inquiry about the checkout code, the processor 211 determines YES in ACT 225 and proceeds to ACT 226. The processor 211 generates checkout data based on sales data of a commodity registered in the registration table 70 in which the checkout code is stored (ACT 226). Then, the processor 211 controls the communication interface 224 to output the checkout data to the checkout machine 24 that has sent the inquiry. With this control, the checkout data is given to the checkout machine 24. At the checkout machine 24 that has received the checkout data, a settlement method is selected. As a settlement method, there are cash settlement, credit card settlement, electronic money settlement, and the like.

The processor 211 of the store server 21 that has output the checkout data confirms whether the credit card settlement has been selected (ACT 227). When a settlement method other than the credit card settlement is selected, the processor 211 determines NO in ACT 227 and proceeds to ACT 231. The processing of ACT 231 will be described later.

On the other hand, if credit card settlement is selected, the processor 211 determines YES in ACT 227 and proceeds to ACT 228. The processor 211 confirms whether credit card settlement is possible (ACT 228). Specifically, the processor 211 confirms whether the identification information of the type “C” is stored in the registration table 70. If the identification information of the type “C” is not stored, the credit card owned by the customer performing the checkout cannot be used at the store. The processor 211 determines NO in ACT 228 and proceeds to ACT 229. The processor 211 controls the communication interface 214 to output a negative acknowledge reply to the checkout machine 24 (ACT 229). With this control, data of a negative acknowledge reply is transmitted from the communication interface 214 to the checkout machine 24. In the checkout machine 24 that has received the data of the negative acknowledge reply, the customer is notified that credit card settlement is not possible.

On the other hand, when the identification information of the type “C” is stored in the registration table 70, the credit card owned by the customer performing the checkout can be used at the store. The processor 211 determines YES in ACT 228 and proceeds to ACT 230. The processor 211 controls the communication interface 214 to output an acknowledge reply to the checkout machine 24 (ACT 230). With this control, acknowledge reply data is transmitted from the communication interface 214 to the checkout machine 24. In the checkout machine 24 which has received the data of the acknowledge reply, the credit card settlement is executed.

Here, if there are a plurality of credit cards that can be used at the store, the customer will need to select or otherwise designate one of the acceptable credit cards. Therefore, the processor 31 of the user terminal 3 controls the touch panel 44 to display a credit card selection screen SC9 (see FIG. 23).

FIG. 23 is an example of the credit card selection screen SC9. As illustrated in FIG. 23, a list L1 of available credit cards is displayed on the credit card selection screen SC9. The list L1 also displays the name, expiration date, and the like of the credit cards. The customer selects one of the credit cards to be used from the list L1. The information of the selected credit card is sent from the access point 25 to the checkout machine 24 via the store server 21, and the credit card settlement is executed.

In ACT 229 or ACT 230, the processor 211 that has output the negative acknowledge reply or the acknowledge reply proceeds to ACT 231.

The processor 211 waits for the completion of the settlement in the checkout machine 24 (ACT 231). When the settlement has been completed, the processor 211 determines YES in ACT 231 and proceeds to ACT 232. The processor 211 confirms whether to issue a receipt as an electronic receipt (ACT 232). That is, the processor 211 confirms whether there is the identification information of the type “R” in the registration table 70.

If there is no identification information of the type “R”, it indicates that the settlement of the customer who does not receive any electronic receipt service has been completed. In this case, the processor 211 determines NO in ACT 232 and ends the information processing of the procedure illustrated in the flowchart of FIG. 13.

On the other hand, if there is the identification information of the type “R”, the settlement of the customer who utilizes the electronic receipt service has been completed, and the processor 211 determines YES in ACT 232 and proceeds to ACT 233. The processor 211 performs electronic receipt processing (ACT 233). Specifically, the processor 211 executes processing of transmitting electronic receipt data, for example, obtained by converting receipt print data into a structured format, to the electronic receipt server together with an electronic receipt ID that is identification information of type “R”. The processing of converting the receipt print data into the structured format may be performed by the store server 21 or may be performed by the checkout machine 24. Alternatively, a device different from the store server 21 or the checkout machine 24 may perform the processing. After finishing the electronic receipt processing, the processor 211 ends the information processing of the procedure illustrated in the flowchart of FIG. 13.

Here, the processor 31 of the user terminal 3 executes the processing of ACT 101 to ACT 107 according to the shopping support program. That is, the processor 31 inputs the store code of the store and the store identification data of the company code, the wireless connection information, the control information, and the like from the data code 5 which is presented in the store.

The processor 31 executes the processing of ACT 126 and ACT 127 according to the shopping support program. That is, the processor 31 inputs the commodity identification data by scanning the barcode of the commodity sold in the store with the camera 35.

The processor 211 of the store server 21 executes the processing of ACT 201 to ACT 203 according to the control program. That is, the processor 211 acquires the store identification data input to the user terminal 3 from the user terminal 3 connected via the communication interface 14.

The processor 211 executes the processing of ACT 204 and ACT 205, and further, the processing of ACT 207 and ACT 209 according to the control program. That is, when the store identification data acquired from the user terminal 3 is valid data, the processor 211 enables the user terminal 3 to be available for commodity registration.

The processor 221 of the virtual POS server 22 executes the processing of ACT 305 and ACT 308 according to the control program. That is, the processor 221 acquires the commodity identification data input to the user terminal 3 from the user terminal 3.

The processor 221 executes the processing of ACT 309 and ACT 310 according to the control program. That is, the processor 221 obtains, from the commodity file 62, commodity data of the commodity identified by the commodity identification data acquired from the user terminal 3 and processes sales data of the commodity of the customer using the user terminal 3 based on the commodity data. Specifically, the processor 221 registers the sales data of the commodity in the registration table 70 for the user terminal 3 that has acquired the commodity identification data.

The processor 211 of the store server 21 executes the processing of ACT 223, ACT 228, and ACT 232 according to the control program. That is, the processor 211 selects valid identification information at the store identified by the store identification data acquired from the user terminal 3 from the identification information stored in the management table 331 in association with the terminal identification data of the user terminal 3.

Then, the processor 211 executes the processing of ACT 224, ACT 229, ACT 230, and ACT 233. That is, the processor 211 executes processing related to the commodity subjected to the sales processing with the identification information. Specifically, when the identification information indicates a membership card, service processing such as a point service or a discount service is executed. If the identification information indicates a credit card, processing of approving credit card settlement is executed. If the identification information indicates an electronic receipt ID, processing of transmitting electronic receipt data is executed.

According to the commodity sales processing system 1 having such a configuration, a communication terminal such as a smartphone, which is personally owned by a customer who has entered the store, can be connected to the store server 21 and the virtual POS server 22 of the store, the terminal can be used for self-service registration. Therefore, the customer can use a personally owned communication terminal as the user terminal 3 to register commodities by himself or herself in a plurality of stores where the commodity sales processing system 1 is installed.

In addition, according to the commodity sales processing system 1, from the plurality of pieces of identification information stored in the management table 331, identification information that is valid at the store is automatically selected, and processing related to a commodity subjected to the sales processing is executed with the identification information, and therefore it is possible to avoid the troublesome work of the customer finding a credit card, a membership card, or the like that can be used in the store. It is also possible to avoid the work of the customer presenting an electronic receipt ID to the clerk.

In the aforementioned embodiments, the virtual POS server 22 creates the registration table 70 for each user terminal 3. Therefore, even if a plurality of customers perform self-service registration by using their communication terminals as the user terminals 3 at the same time, the virtual POS server 22 can correctly deal with the transactions in parallel.

In the above-described embodiments, the commodity sales system 2 includes two different servers, i.e., the store server 21 and the virtual POS server 22. As another embodiment, the store server 21 and the virtual POS server 22 may be integrated into one server.

For example, the processing routine of the store server 21 illustrated in FIG. 10 may be performed by the virtual POS server 22. In such a case, when the processor 221 determines YES in ACT 210 of FIG. 10, the processor 221 executes the processing of ACT 302 of FIG. 11.

In the above-described embodiments, each store provides the two-dimensional data code 5. Instead, each store may provide a one-dimensional barcode. When the user terminal 3 has a contactless IC card reader, an antenna for short-range wireless communication may be provided at each store, and the user terminal 3 may acquire the store setting information 50 by non-contact wireless communication.

In the above-described embodiments, the data code 5 including a store entry flag has been illustrated as an example. In another embodiment, the data code 5 may not include a store entry flag. In such a case, the processor 31 of the user terminal 3 omits the processing step of ACT 106 in FIG. 7, and if the data code 5 is analyzed in ACT 105, proceeds to the processing of ACT 107.

The data structure of the store setting information 50 is not limited to that illustrated in FIG. 2. For example, when the processing is performed only in a store operated by one company, the company code can be omitted from the store setting information 50.

In the above-described embodiments, the management table 331 is stored in the external memory 33 of the user terminal 3. However, the management table 331 does not necessarily have to be stored in the user terminal 3. The management table 331 may be stored in a cloud storage accessible by the user terminal 3 and the commodity sales system 2. When the management table 331 is stored in the cloud storage, the user terminal 3 does not necessarily have to be a smartphone or the like personally owned by the customer. For example, a user terminal owned by a store attached to a shopping cart, a so-called cart terminal may be used. In the case of a cart terminal, the customer performs a login operation before starting to use the cart terminal. For example, the store server 21 receives a login operation from the cart terminal, identifies the customer, and acquires the management table 331 related to the customer. By doing so, it is possible to avoid the troublesome work of the customer finding a card or the like that can be used in the store.

On the other hand, when the management table 331 is stored in the user terminal 3, there is a possible advantage in that a commodity sales processing system can be configured without using a cloud environment.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout system, comprising:
a store server that includes:
a first network interface,
a first memory that stores payment information indicating a payment method accepted at a store, and
a first processor configured to, upon receipt of a request from a customer terminal, control the first network interface to transmit the payment information to the customer terminal; and
a registration server that includes:
a second network interface,
a second memory, and
a second processor configured to:
acquire the payment information from the customer terminal via the second network interface,
upon receipt of a commodity ID for a commodity from the customer terminal via the second network interface, register the commodity ID in the second memory, and
upon receipt of a request for checkout from the customer terminal, perform checkout processing using the registered commodity ID and the payment information.

2. The checkout system according to claim 1, wherein the customer terminal includes:
a third network interface,
a reading device, and
a third processor configured to control the third network interface to transmit a commodity ID to the registration server for a commodity that has been read by the reading device.

3. The checkout system according to claim 2, wherein the third processor is further configured to control the third network interface to establish a connection with the store server using connection information read by the reading device.

4. The checkout system according to claim 3, wherein the connection information read by the reading device is presented as a two-dimensional code.

5. The checkout system according to claim 1, further comprising:
a checkout terminal, wherein
the second processor is further configured to:
upon receipt of a request from the customer terminal for checkout at the checkout terminal, generate a checkout code associated with the registered commodity ID, and
control the second network interface to transmit the generated checkout code to the customer terminal, and
upon receipt of an input of the checkout code, the checkout terminal performs checkout processing based on the registered commodity ID.

6. The checkout system according to claim 5, wherein
the second processor is further configured to, after generating the checkout code, control the second network interface to transmit the checkout code and the registered commodity ID to the store server,
the first processor is further configured to:
upon receipt of the registered commodity ID from the registration server, generate checkout information for performing checkout processing based on the registered commodity ID, and
upon receipt of the checkout code from the checkout terminal, control the first network interface to transmit the checkout information to the checkout terminal, and
upon receipt of the checkout information, the checkout terminal performs the checkout processing.

7. The checkout system according to claim 6, wherein the first processor is further configured to:
acquire membership information indicating a membership status of a customer, and
calculate a reward or a discount using the membership information when generating the checkout information.

8. The checkout system according to claim 6, wherein the first processor is further configured to:
acquire electronic receipt information indicating whether a customer utilizes an electronic receipt service, and
when the customer utilizes the electronic receipt service, generate an electronic receipt during the checkout processing.

9. The checkout system according to claim 1, wherein the customer terminal is a hand-held mobile terminal.

10. The checkout system according to claim 1, wherein the customer terminal is attached to a shopping cart.

11. A checkout method, comprising:
storing, in a store server, payment information indicating a payment method accepted at a store;
upon receipt of a request from a customer terminal, transmitting the payment information from the store server to the customer terminal;
transmitting the payment information from the customer terminal to a registration server;
upon receipt of a commodity ID for a commodity from the customer terminal, registering the commodity ID in the registration server; and
upon receipt of a request for checkout from the customer terminal, performing checkout processing using the registered commodity ID and the payment information.

12. The checkout method according to claim 11, further comprising:
reading the commodity ID using a reading device of the customer terminal; and
transmitting the commodity ID to the registration server from the customer terminal.

13. The checkout method according to claim 12, further comprising:
establishing a connection from the customer terminal to the store server using connection information read by the reading device.

14. The checkout method according to claim 13, wherein the connection information is presented as a two-dimensional code provided at the store.

15. The checkout method according to claim 11, further comprising:
upon receipt of a request from the customer terminal for checkout at a checkout terminal, generating a checkout code associated with the registered commodity ID;
transmitting the generated checkout code from the registration server to the customer terminal; and
upon receipt of an input of the checkout code, performing checkout processing based on the registered commodity ID at the checkout terminal.

16. The checkout method according to claim 15, further comprising:
after generating the checkout code, transmitting the checkout code and the registered commodity ID to the store server from the registration server;
upon receipt of the registered commodity ID from the registration server, generating checkout information for performing checkout processing based on the registered commodity ID;
upon receipt of the checkout code from the checkout terminal, transmitting the checkout information from the store server to the checkout terminal; and
upon receipt of the checkout information, performing the checkout processing at the checkout terminal.

17. The checkout method according to claim 16, further comprising:
acquiring membership information indicating a membership status of a customer; and
calculating a reward or a discount using the membership information when generating the checkout information.

18. The checkout method according to claim 16, further comprising:
acquiring electronic receipt information indicating whether a customer utilizes an electronic receipt service, and
when the customer utilizes the electronic receipt service, generating an electronic receipt during the checkout processing.

19. The checkout method according to claim 11, wherein the customer terminal is a hand-held mobile terminal held by a customer.

20. A checkout apparatus, comprising:
a network interface;
a memory that stores payment information indicating a payment method accepted at a store; and
a processor configured to:
upon receipt of a request from a customer terminal, control the first network interface to transmit the payment information to the customer terminal,
upon receipt of a commodity ID from the customer terminal, register the commodity ID in the memory, and
upon receipt of a request for checkout from the customer terminal, perform checkout processing using the registered commodity ID and the payment information.
